(19) United States
(12) Patent Application Publication
(10) Pub. No.: US 2005/0054362 A1
(43) Pub. Date: Mar. 10, 2005

(54) Method and apparatus for transmit power control during a group call to a plurality of devices

(76) Inventors: Satyanarayan R. Panpaliya, Palatine, IL (US); Vijay Nangia, Schaumburg, IL (US); Joseph E. Phillips, Huntley, IL (US)

Correspondence Address: MOTOROLA, INC., 1303 EAST ALGONQUIN ROAD, IL01/3RD, SCHAUMBURG, IL, 60196, US

(21) Appl. No.: 10/658,172

(22) Filed: Sep. 8, 2003

(51) Int. Cl. H04Q 7/00

(52) U.S. Cl. 455/522

(57) ABSTRACT

A transmitting device (100) transmits a signal on a forward channel (106) at a predetermined power level. Upon receipt of the signal, a receiving device (102), estimates a signal quality for the signal. If the signal quality is below a threshold, the receiving device transmits a power control message on at least a portion of a single reverse channel (104), wherein the power control message requests an increase in transmit power for subsequently received signals, and wherein the single reverse channel is shared by a plurality of receiving devices. The transmitting device adjusts the transmit power level based on observing the reverse channel.

### FIELD OF THE INVENTION

The present invention relates generally to a method and apparatus for transmit power control during a group call to a plurality of devices.

### BACKGROUND OF THE INVENTION

Current two-way radio systems do not have a power control mechanism for a group dispatch type of call in a talk around mode (i.e., a call without a repeater or a base station), which leads to high power consumption and more interference to the adjacent channels.

Periodic transmission of link quality information back to the transmitting device helps to control transmission power in the case of a single transmitter single receiver (“STSR”) radio frequency (“RF”) call. In the case of a single transmitter 100 multiple receivers 102 (“STMR”) group call in talk around mode as illustrated in FIG. 1, however, power control becomes difficult due to bandwidth constraints in a narrowband system which make it impractical to receive independent feedback from every receiving device 102 in the group call. Moreover, the transmitting device 100 has no knowledge of the number and/or identity of the receiving devices 102 involved in the group dispatch call.

Thus, there exists a need for transmit power control during a dispatch call to multiple devices.

### BRIEF DESCRIPTION OF THE FIGURES

A preferred embodiment of the invention is now described, by way of example only, with reference to the accompanying figures in which:

FIG. 1 illustrates a system topology comprising a transmitting device and a plurality of receiving devices in accordance with the present invention;

FIG. 2 illustrates a flowchart of a power control algorithm for the receiving device in accordance with the present invention;

FIG. 3 illustrates a power control threshold and hysteresis loop for power control adaptation for the receiving device in accordance with the present invention;

FIG. 4 illustrates a first example of the format of the reverse channel in accordance with the present invention;

FIG. 5 illustrates a second example of the format of the reverse channel in accordance with the present invention;

FIG. 6 illustrates a third example of the format of the reverse channel in accordance with the present invention;

FIG. 7 illustrates a state machine in the transmitting device for transmit power control in accordance with the present invention; and

FIG. 8 illustrates an example of the state machine of FIG. 7 in accordance with the present invention.

### DETAILED DESCRIPTION OF THE PREFERRED EMBODIMENT

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate identical elements.

The present invention allows multiple receiving devices 102 to provide periodic feedback regarding its individual received signal quality to the transmitting device 100 during a group/dispatch call by allowing the receiving devices 102 to transmit power control (“PC”) messages on the reverse channel 104 when its link quality falls below a threshold. The reverse channel 104 is a common channel for all receiving devices 102 in a group/dispatch call. The present invention further enables the transmitting device 100 to reach an optimum/desired transmit power level and enables the receiving devices 102 to receive signals from the transmitting device 100 having at least threshold link quality by allowing the transmitting device 100 to dynamically adjust the transmit power level based on an observation of the common reverse channel 104.

Let us first discuss the present invention from the perspective of the receiving device 102. The receiving device 102 estimates a received signal quality (“RXQUAL”) of a signal received on a forward channel 106. The estimation of the RXQUAL is a function of one or more parameters, such as, but not limited to, bit error rate (“BER”), message error rate (“MER”), frame error rate (“FER”), received signal strength indicator (“RSSI”), symbol error rate (“SER”), waveform eye opening, frequency/time lock, or the like. If an increase in power is desired based on the RXQUAL measurements, the receiving device 102 schedules the transmission of a PC message on the reverse channel 104; if an increase in power is not desired based on the RXQUAL measurements, the receiving device 102 does not schedule the transmission of a PC message on the reverse channel 104. The PC message is a request from the receiving device 102 to the transmitting device 100 to increase the transmit power level. Thus, on the reverse channel 104, multiple receiving devices 102 involved in the group/dispatch call that require a power boost transmit the same PC message on the reverse channel 104 around the same time.

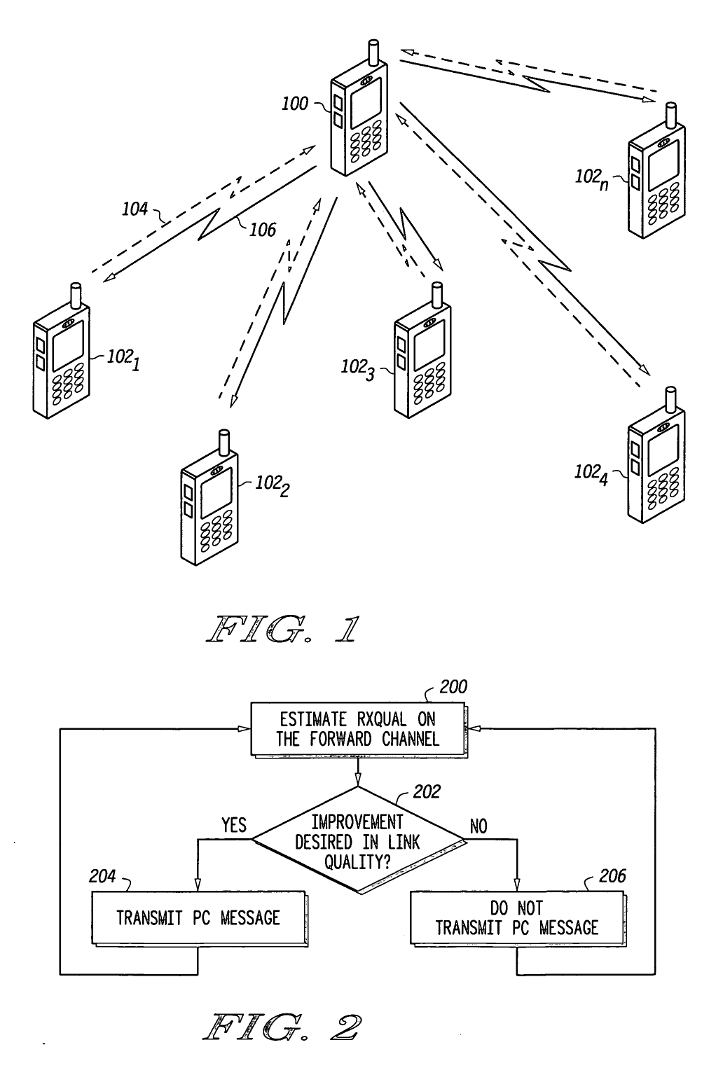

A flowchart of the PC algorithm at the receiving device 104 is illustrated in FIG. 2. As illustrated, the receiving device 102 continuously estimates the RXQUAL of the signals received on the forward channel 106 (at step 200). Based on each RXQUAL measurement, the receiving device 102 determines whether an improvement is desired in the link quality (at step 202). If an improvement in the link quality is desired, the receiving device 102 transmits a PC message to the transmitting device 100 on the reverse channel 104 requesting a power increase and continues to estimate the RXQUAL of the signals received from the transmitting device 100 on the forward channel 106 (at step 204). If an improvement in the link quality is not needed or desired, the receiving device 102 does not transmit a PC message to the transmitting device 100 on the reverse channel 104, but rather just continues to estimate the RXQUAL of the signals received from the transmitting device 100 on the forward channel 106 (at step 206).

Determining whether an improvement is desired in the link quality by the receiving device 102 is better illustrated in FIG. 3. A hysteresis loop 300 in the receiving device 102, as illustrated in FIG. 3, helps the transmitting device 100 in reducing oscillations near the optimum power boundaries; the hysteresis (PC_HYST) loop 300 is included in a power control threshold 302 for the receiving device 102 to dampen the power control oscillations of the transmitting device 100. As illustrated in FIG. 3, if the forward channel measurement indicates a poor RXQUAL measurement, then the receiving device 102 continuously requests an increase in power by transmitting the PC message on the reverse channel 104 until RXQUAL>(PC_THRESH+PC_HYST). Once RXQUAL>(PC_THRESH+PC_HYST), the receiving device 102 does not transmit the PC message on the reverse channel 104 until the RXQUAL falls below the PC threshold 302. In the preferred embodiment, the PC threshold 302 is set to such a value that the speech quality just starts to degrade and that a FER of preferably less that 1% is observed.

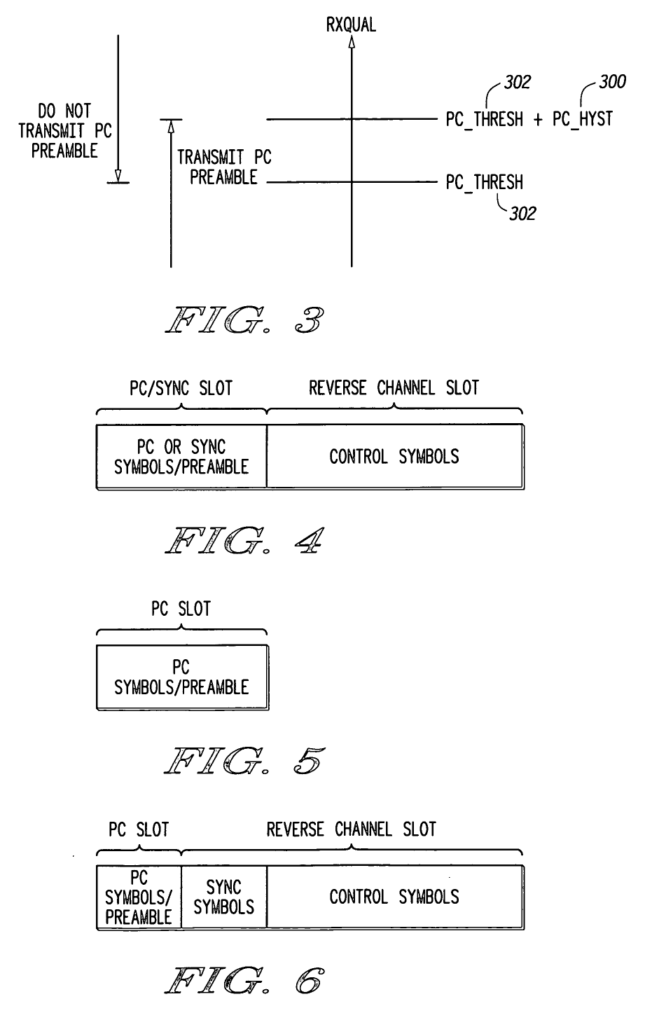

The PC message transmitted by the receiving device 102 on the reverse channel 104 can be designed in multiple ways. For example, the PC message may comprise a PC preamble message and a control message as illustrated in FIG. 4. Alternatively, the PC message may just comprise the PC preamble message as illustrated in FIG. 5. In all cases, the PC message contains at least the PC preamble message. The two-way radio system may support more than one PC message format but the position of the PC preamble message is the same for all supported PC messages. The PC preamble message is a predetermined known message and for example can be a function of known bits, known symbols or known waveform patterns or the like. Receiving devices 102 involved in the group/dispatch call that desire a transmit power increase transmit the same PC preamble message. In one embodiment, the design of the reverse channel format may comprise a dedicated PC slot for transmission of the PC message resulting in time division multiplexing of the PC message on the PC slot and other reverse channel messages on the reverse channel slot as illustrated in FIG. 6. Any message may be transmitted on the reverse channel slot, and for example may include one or more of synchronization message, control message, or data message. The transmitting device 100 may also schedule a transmission on at least a portion of the reverse channel slot.

There is a likelihood of collisions on the reverse channel as more than one device may transmit on the reverse channel. For example, collisions on the PC slot may occur as more than one receiving device 102 may transmit a PC message requesting a transmit power increase. As the same PC preamble message is transmitted, the composite received PC preamble signal can be considered as the PC preamble message being propagated through a multipath channel due to different propagation delays between each pair of transmitting and receiving devices 100, 102. A PC detector (not shown) in the transmitting device 100 can be appropriately designed to detect the presence or absence of the PC preamble signal on the reverse channel 104.

In an alternative embodiment, receiving devices 102 that desire an increase in transmit power may transmit the PC message on at least a portion of the reverse channel 104 that may also be used by other receiving devices 102 that do not desire an increase in transmit power. For example, the design of the reverse channel format may include a common PC/synchronization slot. Receiving devices 102 that desire a transmit power increase may transmit the PC message on the common PC/synchronization slot, while receiving devices 102 that do not desire a transmit power increase but need to transmit some information on the reverse channel 104 may use the PC/synchronization slot to transmit a synchronization message. In such a case, the PC message and the synchronization message may be selected such that the transmitting device 100 can reliably detect them. For example, the messages may be selected from the family of sequences that have good auto-correlation and possibly good cross-correlation properties such as orthogonal Walsh sequences. In addition to the PC/synchronization slot, the reverse channel 104 may have other slots such as the reverse channel slot to transmit other messages, as mentioned above.

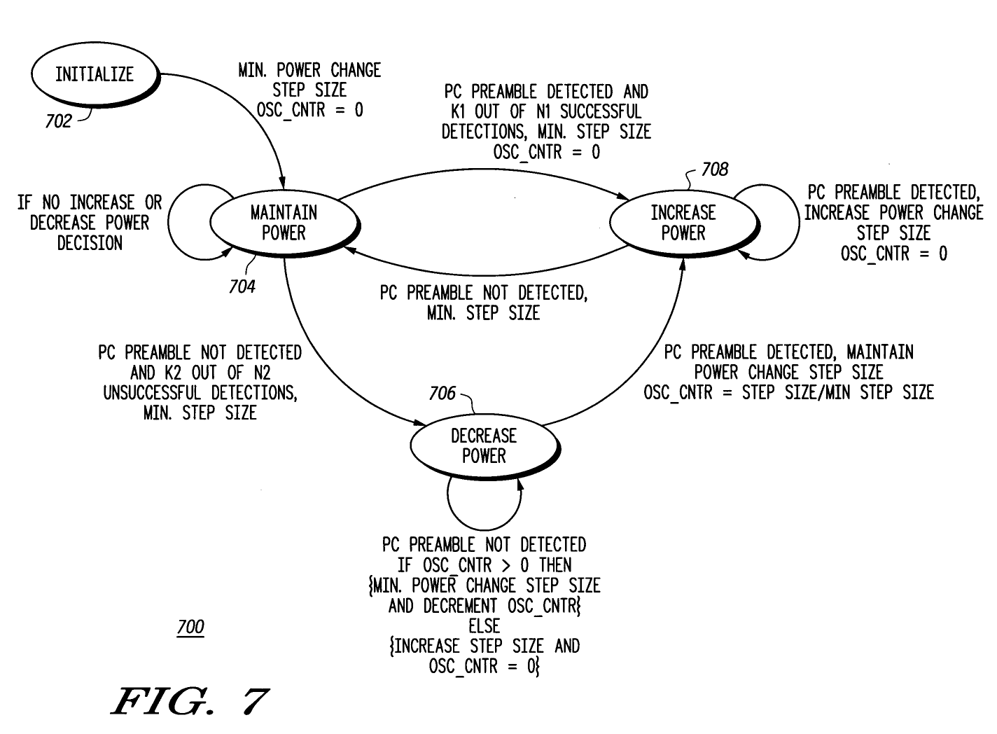

Let us now discuss the present invention from the perspective of the transmitting device 100. The device transmitting on the forward channel 106 initially sets the transmit power level to a predetermined level such as the maximum power level or to a power level where a communication is guaranteed to all intended recipients in a group dispatch call. Thereafter, for power control in a group/dispatch call, the transmitting device 100 executes the power control state machine as illustrated in FIG. 7. The state machine 700 in the transmitting device 100 makes a decision to increase, decrease, or maintain a transmit power level depending on the current power state; thus, the state machine 700 has four power states: INITIALIZE 702, MAINTAIN 704, DECREASE 706 and INCREAESE 708.

The decision to transition from the MAINTAIN power state 704 to either the DECREASE or INCREASE power states 706, 708 includes a voting process. The voting parameters used in the voting process comprise K1, N1, K2 and N2: K1 is the number of PC messages detected in the observation window (i.e., time interval) of N1 reverse channel intervals; K2 is the number of PC messages not detected in the observation window of N2 reverse channel intervals. A PC message may be declared to be detected by the transmitting device 100 if at least the PC preamble message is detected. The voting parameters, K1, N1, K2, N2 determine the nimbleness of the power control algorithm in the transmitting device 100. The state machine 700 at the transmitting device 100 also comprises a power oscillation counter (osc_cntr; not shown). In the preferred embodiment, a power oscillation is considered when the transmitting device 100 transitions from a DECREASE power state 706 to an INCREASE power state 708 and the power oscillation counter is set to a value greater than zero, as will be explained below. The voting process along with the use of the minimum (smallest) power change step size when a power oscillation is detected damps the power control oscillations about the minimum required transmit level for reliable communications. The state machine 700 dynamically adjusts the step size by which the power changes (increases or decreases). The power change step size may be selected from a predetermined set of values or may be calculated based on a function of one or parameters, such as power control state, previous step size value, PC detection, power oscillation counter, or the like.

Referring to FIG. 7, the transmitting device 100 starts in the INITIALIZE power state 702 when it initiates a call. The transmit power level is set at the predetermined level while in the INITIALIZE power state 70; in the preferred embodiment, the transmitting device 100 transmits with maximum power during call initiation. The transmitting device 100 transitions to the MAINTAIN power state 704 with the power oscillation counter set to zero and a minimum power change step size set to a predetermined value (example, 0.5 dB).

First, let us discuss the actions of the transmitting device 100 while operating in the MAINTAIN power state 704 in the present example. While in the MAINTAIN power state 704, if the transmitting device 100 detects a PC message on the reverse channel 104 K1 times within the predefined observation window N1 (i.e., if K1 successful PC detections have occurred within N1) and the transmit power level is not at a predetermined maximum power level, the transmitting device 100 increases the transmit power level by the minimum power change step size, sets the power oscillation counter to zero, if not already set to zero, and transitions from the MAINTAIN power state 704 to the INCREASE power state 708. If the transmitting device 100 does not detect a PC message on the reverse channel 104 K2 times within the predefined observation window N2 (i.e., if K2 unsuccessful PC detections have occurred within N2) and the current transmit power level is not at a predetermined minimum power level, the transmitting device 100 transitions decreases the transmit power level by the minimum power change step size and transitions from the MAINTAIN power state 704 to the DECREASE power state 706. It should be noted that when either K1 or K2 is greater than one, if less than K2 unsuccessful PC detections have occurred within the observation window N2 or if less than K1 successful PC detections have occurred within the observation window N1, the transmitting device 100 maintains the current power level and remains in the MAINTAIN power state 704. Delaying the decision to decrease the transmit power level (by a least K2 frames) during the initial few frames may be advantageous for late-entry receiving devices 102 who have missed the initial call setup signal.

Next, let us discuss the actions of the transmitting device 100 while operating in the DECREASE power state 706. While in the DECREASE power state 706, if the transmitting device 100 does not detect a PC message on the reverse channel 104 and the transmit power level is not already at a predetermined minimum power level, the transmitting device 100 checks the power oscillation counter to see if the power oscillation condition has been met. If no power oscillation is determined (osc-cntr=0), the transmitting device 100 remains in the DECREASE power state 706, increases the power change step size (for example, in a linear or logarithmic fashion), decreases the transmit power level by the current power change step size, and keeps the power oscillation counter value set to zero. If, however, power oscillation is determined (osc_cntr>0), the transmitting device 100 remains in the DECREASE power state 706, decreases the transmit power level by the minimum power change step size, and decrements the power oscillation counter value (preferably by one). On the other hand, while in the DECREASE power state 706, if the transmitting device 100 detects a PC message on the reverse channel 104, the transmitting device 100 transitions from the DECREASE power state 706 to the INCREASE power state 708, maintains the current power change step size, sets the power oscillation counter value to the current power change step size divided by the minimum power change step size, and increases the transmit power level by the current power change step size. It should be noted that a transition from the DECREASE power state 706 to the INCREASE power state 708 is considered a power oscillation about the desired optimum transmit power level and hence a power oscillation flag is set by initializing the oscillation counter to a non-zero value=(step size)/(min. step size).

Finally, let us discuss the actions of the transmitting device 100 while operating in the INCREASE power state 708. While in the INCREASE power state 708, if the transmitting device 100 is still detecting a PC message on the reverse channels 104, the transmitting device 100 remains in the INCREASE power state 708, and if the power level is not already at a predetermined maximum power level, continues to increase the power change step size (for example, in a linear or logarithmic fashion), and resets the power oscillation counter value to zero on each PC message detection. If, however, a PC message is not detected on the reverse channels 104 while currently operating in the INCREASE power state 708, the transmitting device 100 sets the power change step size to the minimum power change step size and transitions from the INCREASE power state 708 to the MAINTAIN power state 704.

Thus, in a group/dispatch call in a narrow band system, the power oscillations cannot be avoided since the bandwidth is not available for the transmitting device 100 to receive feedback regarding received signal quality from all the receiving devices 102. The voting process along with the use of the minimum (smallest) power change step size when a power oscillation is detected by the transmitting device 100 dampens the power control oscillations about the minimum required transmit level.

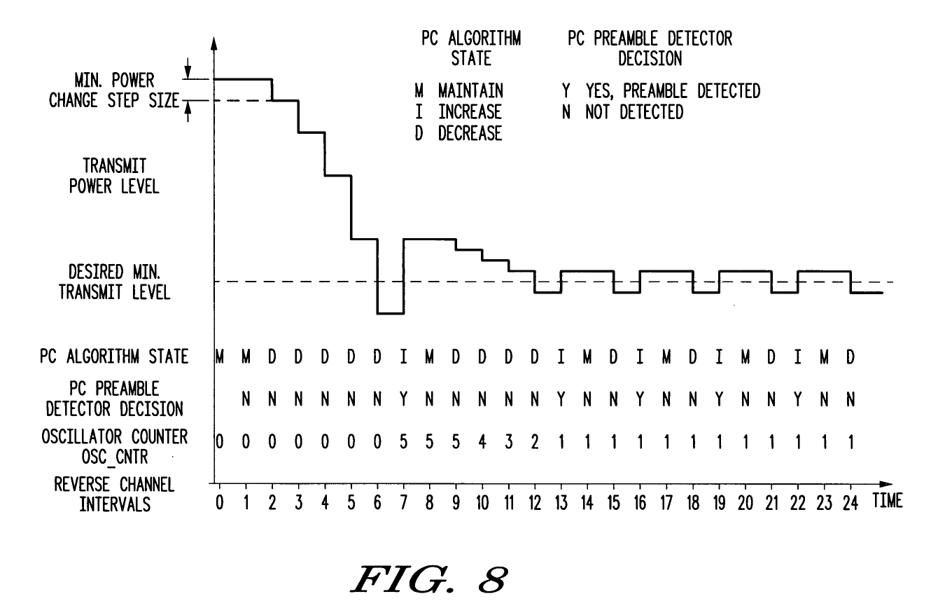

FIG. 8 illustrates an example of the PC algorithm for the transmitting device 100 for voting parameters K1, N1, K2 and N2. In this example, assume that K1=1, N1=1, K2=2 and N2=3. The PC decisions, current power state of the algorithm, and the value of the power oscillator counter are also illustrated in FIG. 8. It can be seen from FIG. 8 that the transmit power level first (y-axis) decreases with increasing step size until it is below the desired power level at which time the power oscillation condition is detected and the power level is increased. Further, the power level changes occur in the minimum power change step size around the desired transmit power level.

In the above example, the values of the voting parameters, K1, N1, K2, N2, have been fixed for the entire call duration. It should be noted, however, that it could be changed dynamically when a condition is detected, such as detection of a power control oscillation. The power change step sizes also may be changed dynamically with possibly different step sizes for power level increase and decrease.

Thus, to describe the example in detail, the transmitting device 100 initially sets the transmit power level to a power level P, which is typically much higher than the desired minimum transmit power level (shown as a dotted line), and the transmit state machine transitions from the INITIALIZE power state 702 to the MAINTAIN power state 704 with the power oscillation counter (osc_cntr) set to zero. During the first K2=2 reverse channel intervals, the transmitting device does not detect the PC message. As a result, the state machine 700 at the transmitting device 100 transitions to the DECREASE power state 706 and the transmitting device 100 decreases the transmit power level by the minimum power change step size.

During the third through the sixth reverse channel intervals, the transmitting device 100 does not detect a PC message on the reverse channel 104, and thus decreases the transmit power level with an increasing power change step size (in this example, in a linear fashion) while the state machine 700 remains in the DECREASE power state 706. It should be noted that after the power level adjustment based on the sixth reverse channel interval, the transmit power level is below the desired minimum transmit power level.

During the seventh reverse channel interval, the transmitting device 100 detects a PC message on the reverse channel 104 that passes the voting process (K1=1 and N1=1). As such, the transmitting device 100 increases the transmit power level by the current (most recent) power change step size and sets the power oscillation counter to five (current step size/min step size).

During the eighth reverse channel interval, the transmitting device 100 does not detect a PC message on the reverse channel 104, and so the state machine 700 transitions to the MAINTAIN power state 704 with the power change step size set to the minimum value; the transmitting device 100 does not change the transmit power level at this time.

During the ninth reverse channel interval, the transmitting device 100 does not detect a PC message on the reverse channel 104 and the state machine 700 transitions to the DECREASE power state 706 as it passes the voting process (K2=2 unsuccessful detections in observation window of N2=3). The transmitting device 100 decreases the transmit power level by the minimum power change step size.

During the tenth through twelfth reverse channel intervals, the transmitting device 100 again does not detect a PC message on the reverse channel 104, thus the state machine 700 remains in the DECREASE power state 704. However, since the power oscillation counter is greater than zero, the transmitting device 100 decreases the transmit power level only by the minimum power change step size for each reverse channel interval. The power oscillation counter is also decreased (by 1 in this example) and its value after detection during the twelfth reverse channel interval is two. It should be noted that the transmit power level after the power adjustment based on twelfth reverse channel interval is again below the desired minimum transmit power level.

During the thirteenth reverse channel interval, the transmitting device 100 detects a PC message on the reverse channel 104, and the state machine 700 transitions to the INCREASE power state 708 with the transmit power level being increased by the current power change step size, which now is the minimum power change step size resulting in the power oscillation counter set to one.

During the fourteenth reverse channel interval, the transmitting device 100 does not detect a PC message on the reverse channel 104, and the state machine 700 transitions to the MAINTAIN power state 704 with the power change step size set to the minimum value; the transmitting device 100 does not change the transmit power level at this time.

During the fifteenth reverse channel interval, the transmitting device 100 does not detect a PC message on the reverse channel 104, and the state machine 700 transitions to the DECREASE power state 706 as it passes the voting process (K2=2 unsuccessful detections in observation window of N2=3). As a result, the transmitting device 100 decreases the transmit power level by the minimum power change step size. It should be noted that the transmit power level after the power adjustment based on fifteenth reverse channel interval is again below the desired minimum transmit power level.

The conditions resulting from the transmitting device 100 detecting PC messages during the sixteenth through eighteenth reverse channel intervals (and future reverse channel intervals in groups of three) are similar to those conditions described above during the thirteenth through fifteenth reverse channel intervals, and the transmit power levels and the state transitions are similar. As a result, the transmit power level is thus reduced close to the desired minimum power level and the transmit power oscillations have been minimized to minimum step size change in power level.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

1. A method of transmit power control during a group call to a plurality of devices comprising the steps of:
receiving a signal on a forward channel;
estimating a signal quality for the signal received on the forward channel; and
if the signal quality is below a threshold, transmitting a power control message on at least a portion of a single reverse channel, wherein the power control message requests an increase in transmit power for subsequently received signals.

2. The method of claim 1 and further comprising the step of continually transmitting the power control message until a signal quality of a subsequently received signal on the forward channel exceeds a second threshold.

3. The method of claim 1 wherein the signal quality is based on at least one of the following measurements: a bit error rate, a message error rate, a frame error rate, a received signal strength indicator, a symbol error rate, a waveform eye opening, a frequency lock and a time lock.

4. The method of claim 1 wherein the power control message is transmitted along with control symbols.

5. The method of claim 1 wherein the power control message is transmitted along with synchronization symbols and control symbols.

6. The method of claim 1 wherein the power control message further provides synchronization.

7. The method of claim 1 further comprising the step of, if the signal quality is above the threshold, not transmitting a power control message on at least a portion of the single reverse channel.

8. A method of transmit power control during a group call to a plurality of devices comprising the steps of:
transmitting at least one signal on a forward channel at a transmit power level; and
adjusting the transmit power level based on observing a single reverse channel, wherein the single reverse channel is shared by a plurality of receiving devices.

9. The method of claim 8 wherein the transmit power level is adjusted by a step size.

10. The method of claim 8 wherein the step of adjusting comprises increasing the transmit power level when a presence of a predetermined number of power control messages is observed on the single reverse channel within a window of time.

11. The method of claim 8 wherein the step of adjusting comprises decreasing the transmit power level when a non-presence of a predetermined number of power control messages is observed on the reverse channel within a window of time.

12. The method of claim 8 and further comprising the steps of:
detecting a transmit power oscillation;
setting an oscillation counter to a predetermined value based on the transmit power oscillation, wherein the predetermined value is a non-zero integer;
decrementing the oscillation counter value when a non-presence of a predetermined number of power control messages is observed on the reverse channel within a window of time; and
decreasing the transmit power level by a predetermined step size.

13. The method of claim 12 wherein the predetermined step size is a minimum value.

14. A method of transmit power control during a group call to a plurality of devices comprising the steps of:
transmitting signals on a forward channel at a transmit power level;
switching between three power states based on one of: a presence of X power control messages on a reverse channel within a first window of time, or a non-presence of Y power control messages on the reverse channel within a second window of time; and
dynamically adjusting the transmit power level for subsequent signals based on a current power state,
wherein a first power state is to maintain a current transmit power level, a second power state is to decrease the current transmit power level, and the third power state is to increase the current transmit power level, and wherein X and Y are integer values.

15. A method of transmit power control during a group call to a plurality of devices comprising the steps of:
setting a transmit power level to a predetermined power level;
transmitting at least one signal on a forward channel at the predetermined power level; and
if a first predetermined number of power control messages are detected on a reverse channel within a first time frame, increasing the transmit power level for subsequent signals; if a second predetermined number of power control messages are not detected on the reverse channel within a second time frame, decreasing the transmit power level for subsequent signals; otherwise, maintaining the transmit power level.

16. The method of claim 15 wherein the predetermined power level is a maximum power level.

17. The method of claim 15 wherein the predetermined power level is a minimum power level.
